(19) United States
(12) Patent Application Publication
(10) Pub. No.: US 2017/0136914 A1
(43) Pub. Date: May 18, 2017

(54) SYSTEMS AND METHODS FOR VISUALIZING BATTERY DATA

(71) Applicant: Johnson Controls Technology Company, Holland, MI (US)

(72) Inventor: Madeline Drake, Richardson, TX (US)

(21) Appl. No.: 14/943,797

(22) Filed: Nov. 17, 2015

(51) Int. Cl. B60L 11/18; H02J 7/00

(52) U.S. Cl. CPC B60L 11/1861; B60L 11/1868; B60L 11/1848; H02J 7/0047

(57) ABSTRACT

A battery system may include a first battery module that outputs a first voltage and a first current, a second battery module configured to output a second voltage and second current, and a display that depicts visualizations. The battery system may include a processor that may receive an indication to monitor a selected battery module comprising the first battery module or the second battery module, receive properties to monitor regarding the selected battery module, receive data regarding the properties from sensor circuitry configured receive the data from one or more sensors associated with the selected battery module, and generate visualizations that correspond to the one or more properties. Each of the visualizations may indicate a current value that corresponds to each of the properties based on the data. The processor may then display the visualizations on the display.

### BACKGROUND

The present disclosure relates generally to the field of batteries and battery systems. More specifically, the present disclosure relates to generating visualizations related to data regarding batteries and battery systems.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

An automotive vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 Volt (V) or 130V systems.

The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) may disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine.

Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60V. For the purposes of the present discussion, it should be noted that mHEVs may not technically use electric power provided directly to the crankshaft or transmission for any portion of the motive force of the vehicle, but an mHEV may still be considered as an xEV since it does use electric power to supplement a vehicle's power needs when the vehicle is idling with internal combustion engine disabled.

In addition, a plug-in electric vehicle (PEV) is any vehicle that can be charged from an external source of electricity, such as wall sockets, and the energy stored in the rechargeable battery packs drives or contributes to drive the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12V systems powered by a lead-acid battery. In fact, xEVs may produce fewer undesirable emission products and may exhibit greater fuel efficiency as compared to traditional internal combustion vehicles. For example, some xEVs may utilize regenerative braking to generate and store electrical energy as the xEV decelerates or coasts. More specifically, as the xEV reduces in speed, a regenerative braking system may convert mechanical energy into electrical energy, which may then be stored and/or used to power to the xEV.

Often, a lithium ion battery may be used to facilitate efficiently capturing the generated electrical energy. More specifically, the lithium ion battery may capture/store electrical energy during regenerative braking and subsequently supply electrical power to the vehicle's electrical system. In addition to the lithium ion batter, a lead acid battery may be used to provide power to various instruments and equipment in a vehicle. In any case, the lithium ion battery and the lead acid battery may enable the vehicle to operate efficiently. Accordingly, it may be useful to use certain visualizations to depict data regarding each of these batteries.

### SUMMARY

Certain embodiments commensurate in scope with the disclosed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In one embodiment, a battery system may include a first battery module that outputs a first voltage and a first current, a second battery module configured to output a second voltage and second current, and a display that depicts visualizations. The battery system may include a processor that may receive an indication to monitor a selected battery module comprising the first battery module or the second battery module, receive properties to monitor regarding the selected battery module, receive data regarding the properties from sensor circuitry configured receive the data from one or more sensors associated with the selected battery module, and generate visualizations that correspond to the one or more properties. Each of the visualizations may indicate a current value that corresponds to each of the properties based on the data. The processor may then display the visualizations on the display.

In another embodiment, a tangible non-transitory, computer readable medium of a lithium ion battery system that may store instructions executable by a processor may include instructions to cause the processor to receive an indication to monitor a selected battery comprising a first battery or a second battery. The processor may then receive one or more properties to monitor regarding the selected battery, receive data regarding the properties from sensor circuitry configured receive the data from one or more sensors associated with the selected battery, and generate one or more visualizations that correspond to the one or more properties. Each of the one or more visualizations may indicate a current value that corresponds to each of the one or more properties based on the data. The processor may then depict the one or more visualizations on a display.

In yet another embodiment, a method may include receiving, via a processor, an indication to monitor a selected battery module comprising a first battery module or a second battery module, receiving one or more properties to monitor regarding the selected battery module, receiving data regarding the properties from sensor circuitry configured receive the data from one or more sensors associated with the selected battery module, and generating one or more visualizations that correspond to the one or more properties. Each of the one or more visualizations may indicate a current value that corresponds to each of the one or more properties based on the data. The method may also include rendering the one or more visualizations on a display.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a vehicle, in accordance with an embodiment;

FIG. 2 is a schematic view of a battery system in the vehicle of FIG. 1, in accordance with an embodiment;

FIG. 3 is a schematic diagram of a passive architecture for the battery system of FIG. 2, in accordance with an embodiment;

FIG. 4 is a graph describing voltage characteristics of a lithium ion battery and a lead-acid battery used in the battery system of FIG. 2, in accordance with an embodiment;

FIG. 5 illustrates a block diagram of a display system for depicting visualizations regarding a battery, in accordance with an embodiment;

FIG. 6 illustrates a flow chart of a method for depicting visualizations regarding a battery via a display, in accordance with an embodiment;

FIG. 7 illustrates an example visualization depicting general information regarding the data being monitored a the sensor circuit, in accordance with an embodiment;

FIG. 8 illustrates a properties visualization that depicts a number of properties that may be monitored by the sensor circuit, in accordance with an embodiment;

FIG. 9 illustrates another example visualization depicting additional information regarding the data being monitored a the sensor circuit, in accordance with an embodiment;

FIG. 10 illustrates a collection of graphs that may be generated based on data regarding a battery, in accordance with an embodiment; and

FIG. 11 illustrates a flow chart of a method for generating a document of the data monitored according to the method of FIG. 6, in accordance with an embodiment.

### DETAILED DESCRIPTION

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The battery systems described herein may be used to provide power to various types of electric vehicles (xEVs) and other high voltage energy storage/expending applications (e.g., electrical grid power storage systems). For example, xEVs may include regenerative braking systems to capture and store electrical energy generated when the vehicle is decelerating or coasting. The captured electrical energy may then be utilized to supply power to the vehicle's electrical system. As another example, battery modules in accordance with present embodiments may be incorporated with or provide power to stationary power systems (e.g., non-automotive systems).

In some embodiments, the battery system may include a lithium ion battery coupled in parallel with one or more other batteries, such as a lead-acid battery, to capture generated electrical energy and supply electrical power to electrical devices. In some embodiments, electrical energy may be generated by a regenerative braking system that converts mechanical energy into electrical energy. The lithium ion battery may then be used to capture and store the electrical energy generated during regenerative braking. Subsequently, the lithium ion battery may supply electrical power to a vehicle's electrical system.

Based on the advantages over traditional gas-power vehicles, manufacturers that generally produce traditional gas-powered vehicles may desire to utilize improved vehicle technologies (e.g., regenerative braking technology) within their vehicle lines. Often, these manufacturers may utilize one of their traditional vehicle platforms as a starting point. Accordingly, since traditional gas-powered vehicles are designed to utilize 12 volt battery systems, a 12 volt lithium ion battery may be used to supplement a 12 volt lead-acid battery. More specifically, the 12 volt lithium ion battery may be used to more efficiently capture electrical energy generated during regenerative braking and subsequently supply electrical energy to power the vehicle's electrical system. Additionally, in a mHEV, the internal combustion engine may be disabled when the vehicle is idle. Accordingly, the 12 volt lithium ion battery may be used to crank (e.g., restart) the internal combustion engine when propulsion is desired.

However, as advancements are made in vehicle technologies, high voltage electrical devices may be included in the vehicle's electrical system. For example, the lithium ion battery may supply electrical energy to an electric motor in a FHEV. Often, these high voltage electrical devices utilize voltages greater than 12 volts, for example, up to 48, 96, or 130 volts. Accordingly, in some embodiments, the output voltage of a 12 volt lithium ion battery may be boosted using a DC-DC converter to supply power to the high voltage devices. Additionally or alternatively, a 48 volt lithium ion battery may be used to supplement a 12 volt lead-acid battery. More specifically, the 48 volt lithium ion battery may be used to more efficiently capture electrical energy generated during regenerative braking and subsequently supply electrical energy to power the high voltage devices.

Thus, the design choice regarding whether to utilize a 12 volt lithium ion battery or a 48 volt lithium ion battery may depend directly on the electrical devices included in a particular vehicle. Although the voltage characteristics may differ, the operational principles of a 12 volt lithium ion battery and a 48 volt lithium ion battery are generally similar. More specifically, as described above, both may be used to capture electrical energy during regenerative braking and subsequently supply electrical power to electrical devices in the vehicle. Additionally, as both operate over a period of time, the operational parameters may change. For example, the temperature of the lithium ion battery may increase the longer the lithium ion battery is in operation.

Accordingly, to simplify the following discussion, the present techniques will be described in relation to a battery system with a 12 volt lithium ion battery and a 12 volt lead-acid battery. However, one of ordinary skill in art should be able to adapt the present techniques to other battery systems, such as a battery system with a 48 volt lithium ion battery and a 12 volt lead-acid battery.

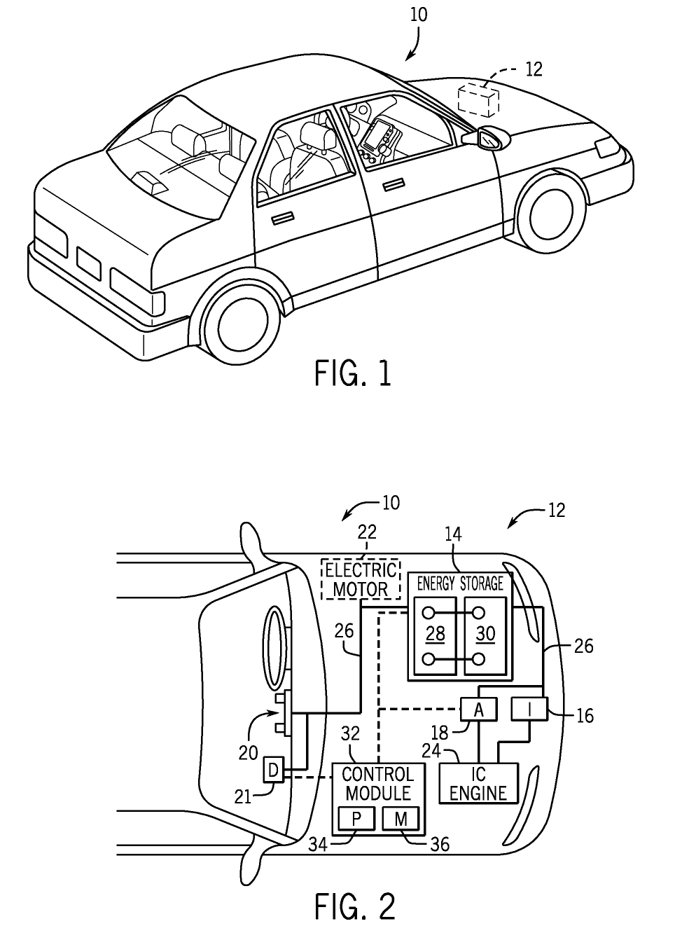

As described above, the operational parameters of a lithium ion battery may change over operation of the vehicle. For example, the temperature of the lithium ion battery may gradually increase during operation. Additionally, other properties related to the lithium ion battery, the lead acid battery, or both may change during operation or over time. In some instances, it may be useful to depict or render visualizations associated with data regarding the lithium ion battery, the lead acid battery, or both on a display within the vehicle. Alternatively, when testing these batteries in laboratory environments, it may be useful to depict visualizations regarding a battery being tested to better or more quickly ascertain properties regarding the battery. Additional details regarding depicting visualizations representing data associated with a battery will be discussed below with reference to FIGS. 1-11.

By way of introduction, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered vehicles.

As discussed above, it would be desirable for a battery system 12 to be largely compatible with traditional vehicle designs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 14 coupled to an ignition system 16, an alternator 18, a vehicle console 20, and optionally to an electric motor 22. Generally, the energy storage component 14 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. Illustratively, in the depicted embodiment, the energy storage component 14 supplies power to the vehicle console 20, a display 21 within the vehicle, and the ignition system 16, which may be used to start (e.g., crank) the internal combustion engine 24.

Additionally, the energy storage component 14 may capture electrical energy generated by the alternator 18 and/or the electric motor 22. In some embodiments, the alternator 18 may generate electrical energy while the internal combustion engine 24 is running. More specifically, the alternator 18 may convert the mechanical energy produced by the rotation of the internal combustion engine 24 into electrical energy. Additionally or alternatively, when the vehicle 10 includes an electric motor 22, the electric motor 22 may generate electrical energy by converting mechanical energy produced by the movement of the vehicle 10 (e.g., rotation of the wheels) into electrical energy. Thus, in some embodiments, the energy storage component 14 may capture electrical energy generated by the alternator 18 and/or the electric motor 22 during regenerative braking. As such, the alternator 18 and/or the electric motor 22 are generally referred to herein as electrical energy generators.

To facilitate capturing and supplying electric energy, the energy storage component 14 may be electrically coupled to the vehicle's electric system via a bus 26. For example, the bus 26 may enable the energy storage component 14 to receive electrical energy generated by the alternator 18 and/or the electric motor 22. Additionally, the bus 26 may enable the energy storage component 14 to output electrical power to the ignition system 16 and/or the vehicle console 20. Accordingly, when a 12 volt battery system 12 is used, the bus 26 may carry electrical power typically between 8-18 volts.

Additionally, as depicted, the energy storage component 14 may include multiple battery modules. For example, in the depicted embodiment, the energy storage component 14 includes a lithium ion (e.g., a first) battery module 28 and a lead-acid (e.g., a second) battery module 30, which each includes one or more battery cells. In other embodiments, the energy storage component 14 may include any number of battery modules. Additionally, although the lithium ion battery module 28 and lead-acid battery module 30 are depicted adjacent to one another, they may be positioned in different areas around the vehicle. For example, the lead-acid battery module 30 may be positioned in or about the interior of the vehicle 10 while the lithium ion battery module 28 may be positioned under the hood of the vehicle 10.

In some embodiments, the energy storage component 14 may include multiple battery modules to utilize multiple different battery chemistries. For example, the lithium ion battery module 28 may improve performance of the battery system 12 since a lithium ion battery chemistry generally has a higher coulombic efficiency and/or a higher power charge acceptance rate (e.g., higher maximum charge current or charge voltage) than a lead-acid battery chemistry. As such, the capture, storage, and/or distribution efficiency of the battery system 12 may be improved.

To facilitate controlling the capturing and storing of electrical energy, the battery system 12 may additionally include a control module 32. More specifically, the control module 32 may control operations of components in the battery system 12, such as relays (e.g., switches) within energy storage component 14, the alternator 18, and/or the electric motor 22. For example, the control module 32 may regulate amount of electrical energy captured/supplied by each battery module 28 or 30 (e.g., to de-rate and re-rate the battery system 12), perform load balancing between the battery modules 28 and 30, determine a state of charge of each battery module 28 or 30, determine temperature of each battery module 28 or 30, determine a predicted temperature trajectory of either battery module 28 and 30, determine predicted life span of either battery module 28 or 30, determine fuel economy contribution by either battery module 28 or 30, control magnitude of voltage or current output by the alternator 18 and/or the electric motor 22, and the like.

Accordingly, the control module (e.g., unit) 32 may include one or more processors 34 and one or more memories 36. More specifically, the one or more processors 34 may include one or more application specific integrated circuits (ASICs), one or more field programmable gate arrays (FPGAs), one or more general purpose processors, or any combination thereof. Generally, the processor 34 may perform computer-readable instructions related to the processes described herein.

Additionally, the one or more memories 36 may include volatile memory, such as random access memory (RAM), and/or non-volatile memory, such as read-only memory (ROM), optical drives, hard disc drives, or solid-state drives. In some embodiments, the control module 32 may include portions of a vehicle control unit (VCU) and/or a separate battery control module.

In certain embodiments, the control module 32 or the processor 34 may receive data from various sensors disposed within the energy storage component 14. The sensors may include a variety of sensors for measuring current, voltage, temperature, and the like regarding the battery module 28 or 30. After receiving data from the sensors, the processor 34 may convert the data into visualizations used to depict the data on a display. As such, the processor 34 may render the visualizations within the display 21, which may be disposed within the vehicle 10. The display 26 may display various images generated by device 10, such as a GUI for an operating system or image data (including still images and video data). The display 21 may be any suitable type of display, such as a liquid crystal display (LCD), plasma display, or an organic light emitting diode (OLED) display, for example. Additionally, the display 21 may include a touch-sensitive element that may provide inputs to the adjust parameters of the control module 32 or data being visualized by the processor 34.

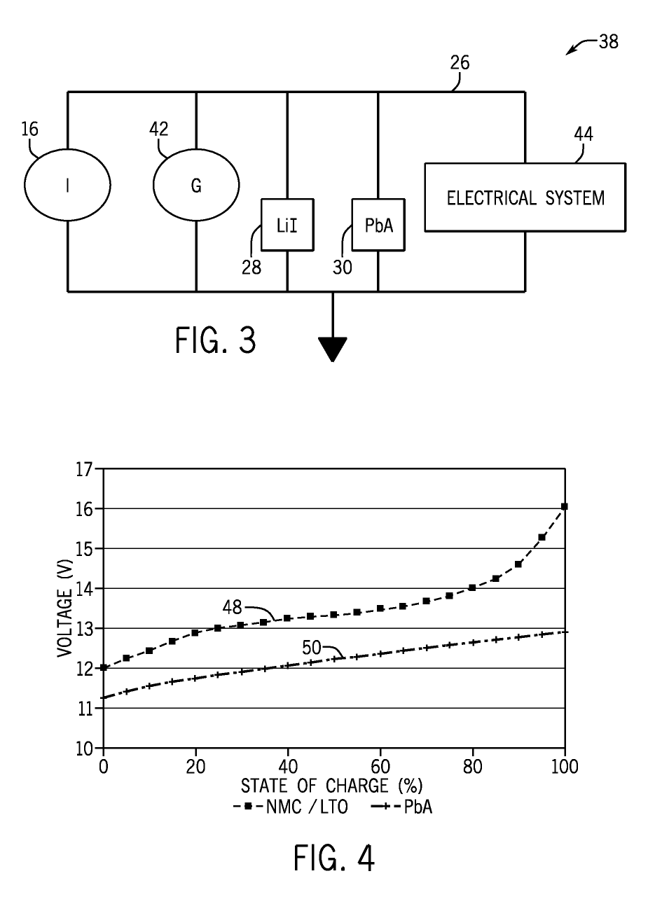

Furthermore, as depicted, the lithium ion battery module 28 and the lead-acid battery module 30 are connected in parallel across their terminals. In other words, the lithium ion battery module 28 and the lead-acid battery module 30 may be coupled in parallel to the vehicle's electrical system via the bus 26. To help illustrate, embodiments of the lithium ion module 28 and the lead-acid battery module 30 coupled in parallel are described in FIG. 3.

More specifically, FIG. 3 describes the lithium ion battery module 28 and the lead-acid battery module 30 in a passive parallel architecture battery system 38. As depicted, the lead-acid battery module 30 and the lithium ion battery module 28 are coupled in parallel with the ignition system 16, an electrical energy generator 42 (e.g., the electric motor 22 and/or alternator 18), and the vehicle's electrical system 44 via the bus 26.

Accordingly, in the passive battery system 38, the operation of the battery module 30 and the lithium ion battery module 28 may be based at least in part on characteristics of each of the batteries. More specifically, the charging of the batteries 28 and 30 may be controlled by characteristics of the lithium ion battery module 28 and the lead-acid battery module 30 and/or the power (e.g., voltage or current) output by the electrical energy generator 42. For example, when the lead-acid battery module 30 is fully charged or close to fully charged (e.g., generally full state of charge), the lead-acid battery module 30 may have a high internal resistance that steers current toward the lithium ion battery module 28. Additionally, when the open-circuit voltage of the lithium ion battery module 28 is higher than the voltage output by the electrical energy generator 42, the lithium ion battery module 28 may cease capturing additional electrical energy.

Similarly, the discharging of the batteries 28 and 30 may also be based at least in part on characteristics of the lithium ion battery module 28 and the lead-acid battery module 30. For example, when the open-circuit voltage of the lithium ion battery module 28 is higher than the open-circuit voltage of the lead-acid battery module 30, the lithium ion battery module 28 may provide power by itself, for example to the electrical system 44, until it nears the open-circuit voltage of the lead-acid battery module 30.

As can be appreciated, the characteristics of the lithium ion battery module 28 may vary when different configurations (e.g., chemistries) are used. In some embodiments, the lithium ion battery module 28 may be a lithium nickel manganese cobalt oxide (NMC) battery, a lithium nickel manganese cobalt oxide/lithium-titanate (NMC/LTO) battery, a lithium manganese oxide/lithium-titanate (LMO/LTO) battery, a nickel-metal hydride (NiMH) battery, a nickel-zinc (NiZn) battery, a lithium iron phosphate (LFP) battery, or the like. More specifically, an NMC battery may utilize battery cells having a lithium nickel manganese cobalt oxide cathode with a graphite anode, an NMC/LTO battery may utilize battery cells having a lithium manganese oxide cathode with a lithium-titanate anode, an LMO/LTO battery may utilize battery cells having a lithium manganese oxide cathode and a lithium-titanate anode, and an LFP battery may utilize battery cells having a lithium iron phosphate cathode and a graphite anode.

The battery chemistries utilized in the lithium ion battery module 28 may be selected based on desired characteristics, such as coulombic efficiency, charge acceptance rate, power density, and voltage overlap with the lead-acid battery. For example, the NMC/LTO battery chemistry may be selected due to its high specific power at 50% state of charge (e.g., 3700 W/kg) and/or due to its high discharge current (e.g., 350A), which may enable the lithium ion battery module 28 to supply a greater amount of electrical power, for example, to power a high voltage device.

Although the techniques described herein may be adapted to a number of different battery chemistries, to simplify the following discussion, the lithium ion battery module 28 will be described as an NMC/LTO battery. To help illustrate the operation (e.g., charging/discharging) of the batteries 28 and 30, the voltage characteristics of the lithium ion battery module 28 and the lead-acid battery module 30 in a 12 volt battery system 12 are described in FIG. 4. It should be appreciated that the voltage characteristics described in FIG. 4 are merely intended to be illustrative and not limiting.

More specifically, FIG. 4 is a plot that describes the open-circuit voltage of the lithium ion battery module 28 with a NMC/LTO voltage curve 48 and the open-circuit voltage of the lead-acid battery module 30 with a PbA voltage curve 50 over the batteries' total state of charge ranges (e.g., from 0% state of charge to 100% state of charge), in which state of charge is shown on the X-axis and voltage is shown on the Y-axis. As described by the NMC/LTO voltage curve 48, the open-circuit voltage of the lithium ion battery module 28 may range from 12 volts when it is at 0% state of charge to 16.2 volts when it is at 100% state of charge. Additionally, as described by the PbA voltage curve 50, the open-circuit voltage of the lead-acid battery module 30 may range from 11.2 volts when it is at 0% state of charge to 12.9 volts when it is at 100% state of charge.

As such, the lithium ion battery module 28 and the lead-acid battery module 30 may be partial voltage matched because the NMC/LTO voltage curve 48 and the lead-acid voltage curve 50 partially overlap. In other words, depending on their respective states of charge, the open-circuit voltage of the lead-acid battery module 30 and lithium ion battery module 28 may be the same. In the depicted embodiment, the lead-acid battery module 30 and the lithium ion battery module 28 may be at approximately the same open-circuit voltage when they are both between 12-12.9 volts. For example, when the lithium ion battery module 28 is at 25% state of charge and the lead-acid battery module 30 is at a 100% state of charge, both will have an open-circuit voltage of approximately 12.9 volts. Additionally, when the lithium ion battery is at 15% state of charge and the lead-acid battery is at 85% state of charge, both will have an open-circuit voltage of approximately 12.7 volts.

Thus, returning to FIG. 3, the operation of the electrical energy generator 42 may be used to control operation of the battery system 12. For example, when the electrical energy generator 42 has a variable output voltage, the voltage characteristics of the batteries 28 and 30 and/or the voltage output by the electrical energy generator 42 may be used to control operation of the battery system 12. More specifically, when the voltage output by the electrical energy generator 42 is variable (e.g., a range of output voltages between 8-18 volts), the amount of charging/discharging performed and the amount of energy stored in the lithium ion battery module 28 may be controlled by determining a specific voltage to be output by the electrical energy generator 42. For example, when the electrical energy generator 42 outputs a voltage greater than or equal to 16.2 volts, both the lithium ion battery module 28 and the lead-acid battery module 30 may both utilize their full storage capacity (e.g., first amount of storage capacity up 100% state of charge) to capture generated electrical energy.

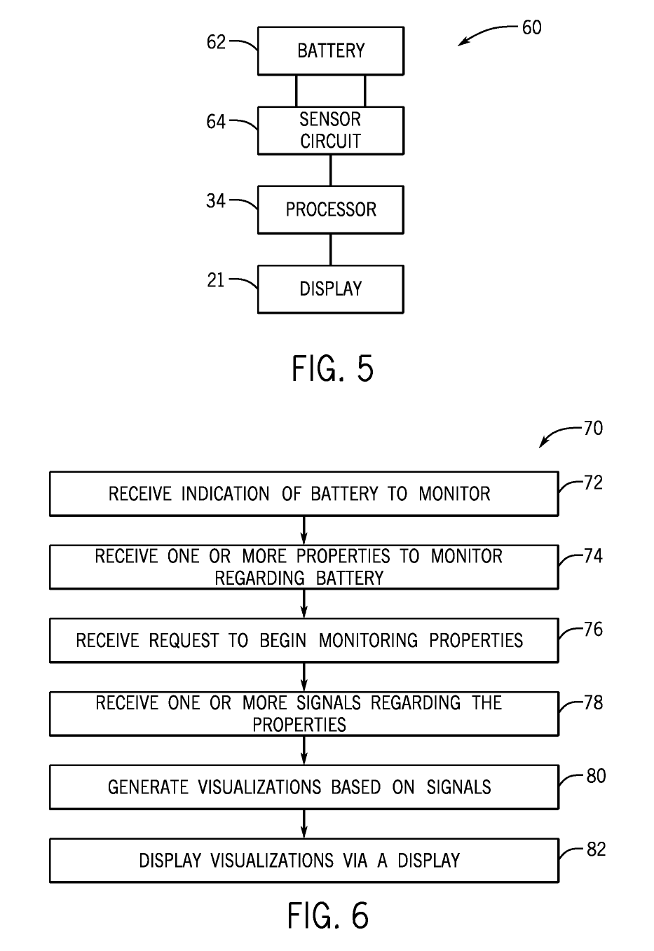

With the foregoing in mind, to ensure that the battery system 12 is operating properly, it may be useful to generate visualizations that detail some of the properties regarding the battery system 12, the energy storage system 14, the battery module 28, or the battery module 30. As such, FIG. 5 illustrates a block diagram of a display system 60 that may display visualizations depicting data regarding one or more batteries in the vehicle 10. Although the display system 60 is described with reference to the vehicle 10, it should be noted that in certain embodiments, the display system 60 may be implemented in another environment outside of the vehicle 10, such as a laboratory environment or the like.

Referring to FIG. 5, the display system 60 may include a battery 62, a sensor circuit 64, the processor 34, and the display 21. The battery 62 may be any type of battery, such as the lithium ion battery 28 or the lead acid battery 30 mentioned above. The sensor circuit 64 may include one or more sensors that may be physically disposed on the battery 62 or coupled to the battery 62 to acquire measurements regarding the battery 62. By way of example, the sensor circuit 64 may include a voltage sensor that may determine an open circuit voltage of the battery 62. Additionally, the sensor circuit 64 may include a voltage sensor coupled to the bus 26 and may determine a bus voltage of the bus 26.

In another example, the sensor circuit 64 may include a resistor or shunt that may measure an amount of current conducting within the battery 62 or from the battery 62. The sensor circuit 64 may also include a temperature sensor that may detect a temperature of the battery 62.

In one embodiment, the sensor circuit 64 may include a controller area network (CAN) interface that may interface with a number of sensors disposed within the battery 62, the energy storage system 14, or the like. The CAN interface may couple to an RS-232 communication link, a USB communication link, or the like to transmit data to a computing device, the processor 34, or any other suitable processing machine.

After the sensor circuit 64 transmits the sensor data to the processor 34, the processor 34 may generate visualizations regarding the sensor data. The processor 34 may then depict the visualizations on the display 21. In certain embodiments, the processor 34 may receive inputs from a user indicating which sensor measurements to display. As such, the user may control an amount of data depicted on the display 21 and view information that the user desires to view. Moreover, by depicting the sensor data using visualizations, as opposed to raw data, the display 21 may enable the user to ascertain the properties of the battery 62 more quickly.

Keeping the foregoing in mind, FIG. 6 illustrates a flow chart of a method 70 for depicting visualizations regarding data associated with a battery via the display 21. Although the method 70 will be described in a particular order, it should be understood that the method 70 may be performed in any suitable order. Further, although the method 70 will be described as being performed by the processor 34, it should be understood that the method 70 may be performed by any suitable processor within the vehicle 10, a general purpose computer, a laptop computer, a tablet computer, a mobile computer, or the like.

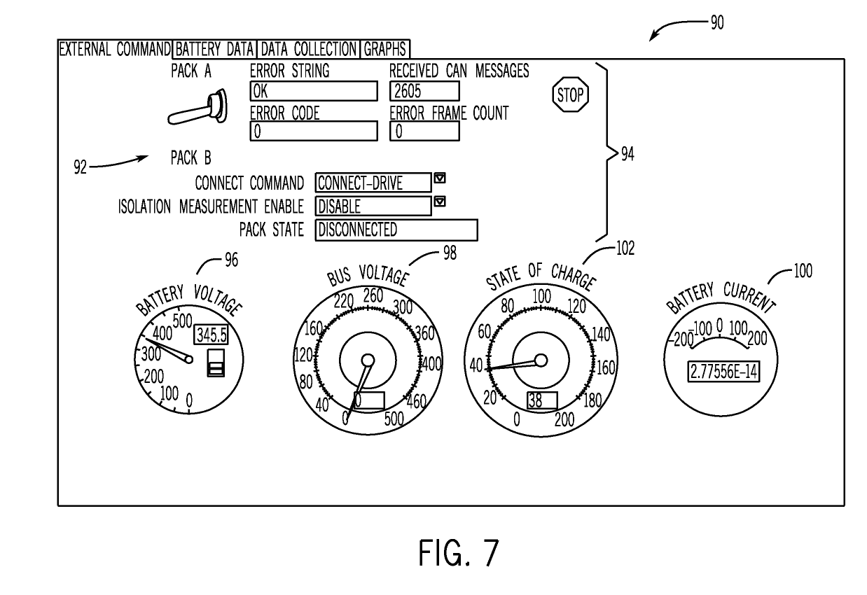

Referring now to FIG. 6, at block 72, the processor 34 may receive an indication of a particular battery to monitor from the user. The processor 34 may receive the input via the display 21 itself or via an input device that may interact with the processor. In one embodiment, the processor 34 may generate an initial visualization that includes general information regarding the data that may be available to monitor. For example, FIG. 7 illustrates an example visualization 90 depicting general information regarding the data being monitored via the sensor circuit 64.

In one embodiment, the visualization 90 may include a selector visualization 92 that may select a particular battery to monitor. The selector visualization 92 depicts two battery packs: pack A and pack B. Upon receiving a selection of one of these two battery packs, the processor 34 may identify communication channels that may transmit data related to the selected battery pack.

In addition to the selector visualization 92, the visualization 90 may include general data fields 94 that may provide information such as a number of CAN messages received, a number of errors received (e.g., error frame count), an error code received, an error string that corresponds to the received error code and may generally describe the respective error, and the like. Additional information included in the general data fields 94 may include a connect command input, an isolation measurement enable input, and a pack state status. As such, the user may select a connect command input such as connect-drive mode, connect-charge mode, or disconnect.

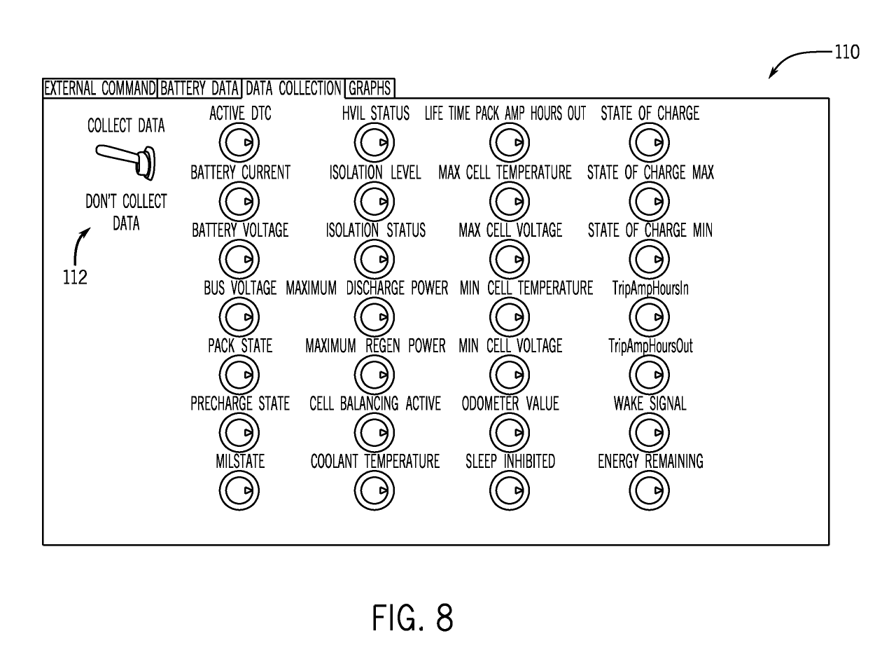

After receiving the input regarding the battery to monitor, the processor 34 may, at block 74, receive one or more properties regarding the selected battery. The selected properties may correspond to various characteristics regarding the battery, a bus coupled to the battery, and the like. For example, FIG. 8 illustrates a properties visualization 110 that depicts a number of properties that may be monitored by the sensor circuit 64. The properties visualization 110 may include, for example, an active dynamic traction control input, a battery current input, a battery voltage input, a bus voltage input, a pack state input, a precharge state input, a MIL state, high voltage interlock status input, an isolation level input, an isolation status input, a maximum discharge power input, a maximum regenerative power input, a cell balancing active input, a coolant temperature input, a life time pack amp hours output input, a maximum cell temperature input, a maximum cell voltage input, a minimum cell voltage input, an odometer value, a sleep inhibited input, a state of charge input, a state of charge maximum input, a state of charge minimum input, a trip amp hours in input, a trip amp hours out input, a wake signal input, an energy remaining input, and the like. Each of these inputs may cause the processor 34 to begin monitoring the respective property and display the resulting data in the visualization 90 or the like.

Upon receiving the properties to monitor, the processor 34 may, at block 76, receive a request to begin actively monitoring the selected properties. In one embodiment, the visualization 110 may include an activation visualization 112 that may include an input that causes the processor 34 to begin receiving data regarding the selected properties from the sensor circuit 64 or the like.

Accordingly, at block 78, the processor 34 may receive one or more signals from sensors or the sensor circuit 64 regarding the properties selected at block 74. After receiving the signals, the processor, at block 80, may generate visualizations based on the signals.

At block 80, the processor 34 may then display the generated visualizations via the display 21 or the like. In one embodiment, the visualizations may be previously generated by the processor 34, as depicted in the visualization 90. In this case, processor 34 may modify the generated visualization to reflect the signal or data being received.

With this in mind and referring back to FIG. 7, the visualization 90 may include a battery voltage visualization 96, a bus voltage visualization 98, a battery current visualization 100, and a state of charge visualization 102 that may depict the battery voltage, the bus voltage, the battery current, and the state of charge, respectively, in an analog visualization or graphic. For instance, each of the battery voltage visualization 96, the bus voltage visualization 98, the battery current visualization 100, and the state of charge visualization 102 includes a range of values and a pointer indicating a current measurement with respect to the range of values.

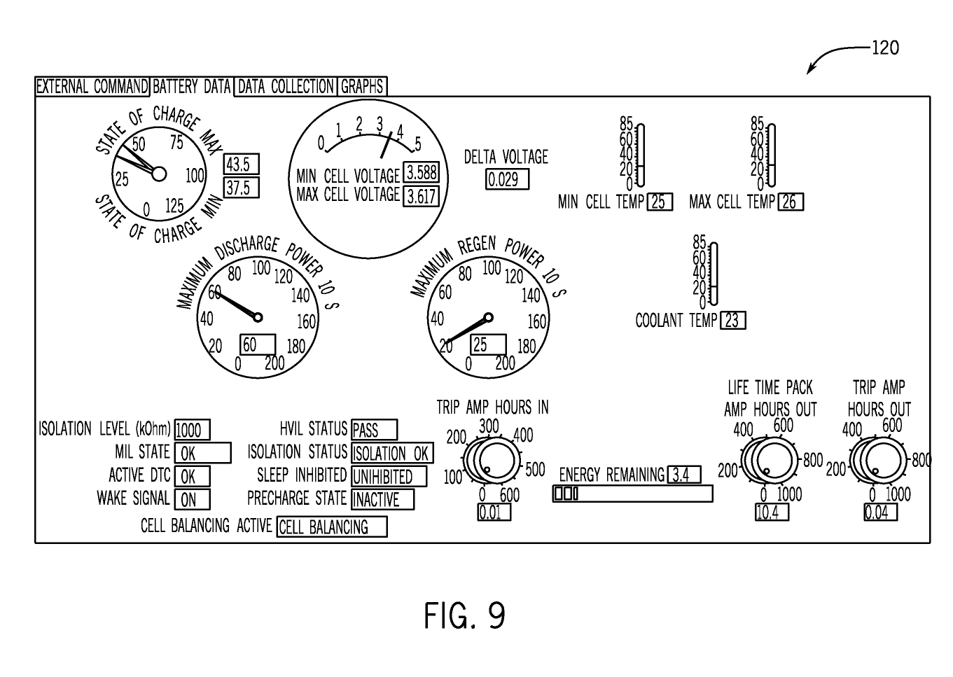

In addition to the visualizations depicted in FIG. 8, FIG. 9 illustrates a visualization 120 that includes additional visualizations that may be generated based on the properties received at block 74. For instance, the visualization 120 may include a visualization to indicate the maximum state of charge and the minimum state of charge, the maximum cell voltage and the minimum cell voltage, the maximum cell temperature and the minimum cell temperature, the maximum discharge power, the maximum regenerative power, the coolant temperature, and other properties that are discussed above with reference to block 74.

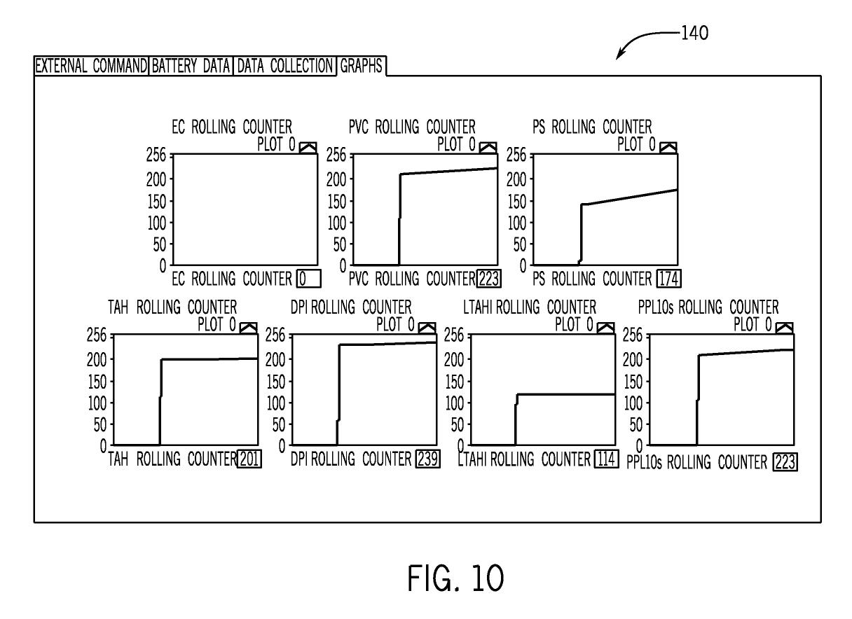

In some embodiment, the processor 34 may depict the data received via the sensor circuitry 64 as a collection of graphs. For example, FIG. 10 illustrates a collection of graphs 140 that may be generated based on data acquired regarding the battery 62. The collection of graphs may include a rolling counter to indicate a current value of the measurements associated with the data received via the sensor circuitry 64. Each graph depicted on the collection of graphs 140 may illustrate how the values of the respective data change over time. By presenting the collection of graphs 140 via the display 21, the user may quickly assess how the various properties of the battery 62 are performing over time.

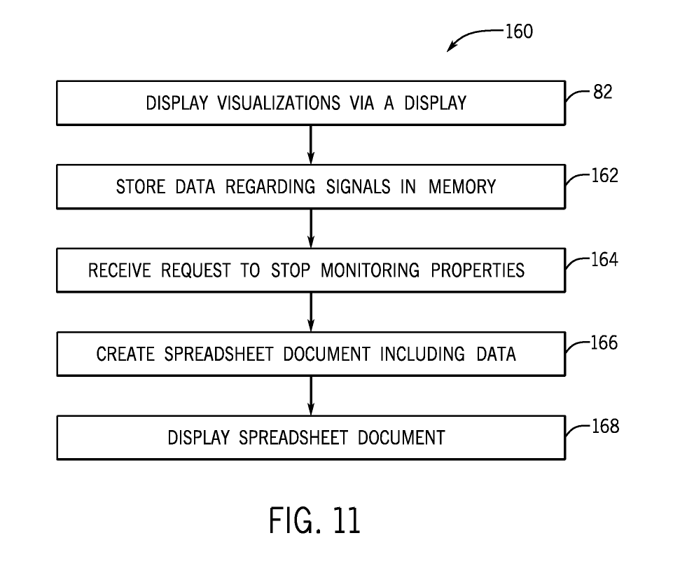

With the foregoing in mind, after displaying the visualizations of the monitored data, the processor 34 may store data related to the visualizations in a memory, such that it may be reproduced as a report or as some document. FIG. 11 illustrates a flow chart of a method for generating a document of the data monitored according to the method of FIG. 6. As mentioned above with regard to the method 70, although the following description of the method 160 is detailed in a particular order, it should be noted that the method 160 may be performed in any suitable order. Moreover, although the method 160 is described as being performed by the processor 34, it should be understood that the method 160 may be performed by any suitable processor or computing device.

Referring now to FIG. 11, in one embodiment, the method 160 may continue after the block 82 of the method 70. However, in other embodiments, the method 160 may be performed at any suitable time. After the processor 34 displays the visualizations at block 82 of the method 70, the processor 34 may proceed to block 162 of the method 160.

At block 162, the processor 34 may store data regarding the signals received at block 78 of the method 70 or data received via the sensor circuitry 64 in a memory or a storage component. The memory may include the memory 36 described above with reference to FIG. 1 or may include a separate electronic storage device communicatively coupled to the processor 34. In some embodiments, the processor 34 may send the data to a cloud-computing system or server device to store the data remotely from the location of the processor 34.

At block 164, the processor 34 may receive a request to stop monitoring the properties regarding the battery 62. The request may be received via an input received at the display 21, using an input structure, or the like.

Upon receiving the request to stop monitoring properties, at block 166, the processor 34 may create a spreadsheet document that includes the data stored by the processor at block 162. In one embodiment, the spreadsheet document may be organized according to measurement or data type and a time at which the data was acquired. At block 166, the processor 34 may begin to generate the spreadsheet document immediately after the processor 34 receives the request to stop monitoring properties at block 164. However, in some embodiments, the processor 34 may prompt the user via the display 21 to indicate whether the user desires to create a spreadsheet document that includes the data. After creating the spreadsheet document at block 166, the processor 34, at block 168, may display the spreadsheet document via the display 21.

Thus, one or more of the disclosed embodiments, alone or on combination, may provide one or more technical effects including providing data regarding a battery system via a display within the vehicle or outside of the vehicle. By providing visualizations regarding the battery system, the systems described herein enable a user to quickly assess various properties regarding the battery system, as compared to reviewing a stream of raw data outputs. The technical effects and technical problems in the specification are exemplary and are not limiting. It should be noted that the embodiments described in the specification may have other technical effects and can solve other technical problems.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A battery system configured to be used in an automotive vehicle, wherein the battery system comprises:
a first battery module configured to output a first voltage and a first current;
a second battery module configured to output a second voltage and second current;
a display configured to depict one or more visualizations; and
a processor configured to:
receive an indication to monitor a selected battery module comprising the first battery module or the second battery module;
receive one or more properties to monitor regarding the selected battery module;
receive data regarding the properties from sensor circuitry configured receive the data from one or more sensors associated with the selected battery module;
generate one or more visualizations that correspond to the one or more properties, wherein each of the one or more visualizations is configured to indicate a current value that corresponds to each of the one or more properties based on the data; and
display the one or more visualizations on the display.

2. The battery system of claim 1, wherein the first battery module is configured to electrically couple to a regenerative braking system.

3. The battery system of claim 1, wherein the second battery module is configured to be electrically coupled in parallel with the first battery module.

4. The battery system of claim 1, wherein the second battery module is configured to be electrically coupled to a regenerative braking system.

5. The battery system of claim 1, wherein the first battery module comprises a lithium ion battery and the second battery module comprises a lead-acid battery.

6. The battery system of claim 1, wherein the one or more properties comprise an active dynamic traction control, a battery current, a battery voltage, a bus voltage, a pack state, a precharge state, a MIL state, high voltage interlock status, an isolation level, an isolation status, a maximum discharge power, a maximum regenerative power, a cell balancing active, a coolant temperature, a life time pack amp hours output, a maximum cell temperature, a maximum cell voltage, a minimum cell voltage, an odometer value, a sleep inhibited, a state of charge, a state of charge maximum, a state of charge minimum, a trip amp hours in, a trip amp hours out, a wake signal, and an energy remaining value.

7. The battery system of claim 1, wherein the one or more visualizations comprise an analog graphic comprising a range of values associated with the selected battery module and a pointer configured to indicate a current value associated with a respective property of the one or more properties.

8. The battery system of claim 1, wherein the processor is configured to:
store the data in a memory or storage component;
receive an input configured to stop the processor from receiving the data; and
automatically generate a spreadsheet document comprising the data.

9. The battery system of claim 9, wherein the spreadsheet document is organized with regard to the one or more properties and one or more times at which the data was acquired.

10. A tangible non-transitory, computer readable medium of a lithium ion battery system configured to store instructions executable by a processor, wherein the instructions comprise instructions to cause the processor to:
receive an indication to monitor a selected battery comprising a first battery or a second battery;
receive one or more properties to monitor regarding the selected battery;
receive data regarding the properties from sensor circuitry configured receive the data from one or more sensors associated with the selected battery;
generate one or more visualizations that correspond to the one or more properties, wherein each of the one or more visualizations is configured to indicate a current value that corresponds to each of the one or more properties based on the data; and
depict the one or more visualizations on a display.

11. The computer-readable medium of claim 10, wherein the first battery is configured to be electrically coupled in parallel to the second battery.

12. The computer-readable medium of claim 10, wherein the first battery comprises a lithium ion battery and the second battery comprises a lead acid battery.

13. The computer-readable medium of claim 10, wherein the one or more properties comprise an active dynamic fraction control, a battery current, a battery voltage, a bus voltage, a pack state, a precharge state, a MIL state, high voltage interlock status, an isolation level, an isolation status, a maximum discharge power, a maximum regenerative power, a cell balancing active, a coolant temperature, a life time pack amp hours output, a maximum cell temperature, a maximum cell voltage, a minimum cell voltage, an odometer value, a sleep inhibited, a state of charge, a state of charge maximum, a state of charge minimum, a trip amp hours in, a trip amp hours out, a wake signal, an energy remaining value, or any combination thereof.

14. The computer-readable medium of claim 10, wherein the one or more visualizations comprise an analog graphic comprising a range of values associated with the selected battery module and a pointer configured to indicate a current value associated with a respective property of the one or more properties.

15. The computer-readable medium of claim 11, wherein the instructions cause the processor to:
store the data in a memory or storage component;
receive an input configured to stop the processor from receiving the data; and
automatically generate a spreadsheet document comprising the data.

16. A method, comprising:
receiving, via a processor, an indication to monitor a selected battery module comprising a first battery module or a second battery module;
receiving one or more properties to monitor regarding the selected battery module;
receiving data regarding the properties from sensor circuitry configured receive the data from one or more sensors associated with the selected battery module;
generating one or more visualizations that correspond to the one or more properties, wherein each of the one or more visualizations is configured to indicate a current value that corresponds to each of the one or more properties based on the data; and
rendering the one or more visualizations on a display.

17. The method of claim 16, wherein the one or more properties comprise an active dynamic traction control, a battery current, a battery voltage, a bus voltage, a pack state, a precharge state, a MIL state, high voltage interlock status, an isolation level, an isolation status, a maximum discharge power, a maximum regenerative power, a cell balancing active, a coolant temperature, a life time pack amp hours output, a maximum cell temperature, a maximum cell voltage, a minimum cell voltage, an odometer value, a sleep inhibited, a state of charge, a state of charge maximum, a state of charge minimum, a trip amp hours in, a trip amp hours out, a wake signal, and an energy remaining value.

18. The method of claim 16, comprising:
storing the data in a memory or storage component;
receiving an input configured to stop the processor from receiving the data; and
automatically generating a spreadsheet document comprising the data.

19. The method of claim 18, wherein the spreadsheet document is organized with regard to the one or more properties and one or more times at which the data was acquired.

20. The method of claim 16, wherein the one or more visualizations comprise an analog graphic comprising a range of values associated with the selected battery module and a pointer configured to indicate a current value associated with a respective property of the one or more properties.
